(19) United States
(12) Patent Application Publication
(10) Pub. No.: US 2014/0340980 A1
(43) Pub. Date: Nov. 20, 2014

(54) MULTI-STAGE ACCURATE BLENDING SYSTEM AND METHOD

(71) Applicant: Asahi Kasei Bioprocess, Inc., Glenview, IL (US)

(72) Inventor: Michael BRANDT, Cassopolis, MI (US)

(73) Assignee: Asahi Kasei Bioprocess, Inc., Glenview, IL (US)

(21) Appl. No.: 14/258,913

(22) Filed: Apr. 22, 2014

Related U.S. Application Data
(60) Provisional application No. 61/814,647, filed on Apr. 22, 2013.

(51) Int. Cl. B01F 15/04; B01F 3/08

(52) U.S. Cl. CPC B01F 15/0408; B01F 3/0803; B01F 2215/04
USPC 366/152.4; 366/152.1

(57) ABSTRACT

An accurate blending system for blending first and second liquid components includes a first feed adapted to communicate with a supply of the first component and a second feed adapted to communicate with a supply of the second component. A shear blender is in communication with the first and second feeds. A first sensor is in communication with an outlet of the shear blender. A controller is in communication with the first sensor so that a first characteristic of a solution exiting the shear blender can be detected. The controller is also in communication with the second feed so that delivery of the second component to the shear blender can be controlled based upon the detected first characteristic.

### CLAIM OF PRIORITY

This application claims priority to U.S. Provisional Application No. 61/814,647, filed on Apr. 22, 2013, the contents of which is incorporated herein by reference.

### FIELD OF THE INVENTION

The present invention generally relates to liquid blending systems and methods and, more particularly, to a system that accurately blends two or more liquids together so that solutions having the desired concentrations of components and/or other characteristics, such as pH, conductivity, organic composition, viscosity or optical properties, etc. are created.

### BACKGROUND

A prior art multi-stage accurate blending system and method is illustrated in commonly assigned U.S. Pat. No. 8,271,139 to Bellafiore et al. While the system of the '139 patent performs well and is largely accurate for the purpose and functionality of blending two or more liquids together so that solutions having the desired concentrations of components and/or other characteristics may be created, the hold-up volume of the mixing loop (including sensors in loop) of the '139 patent suffers from a number of disadvantages. These disadvantages include the following:

1) impeding rapid change to the blending solutions (through exponential dilution of the mixing loop volume) thus extending the time to bring the blend products into specification and thereby negatively impacting the efficiency of the system by extending the product to waste,

2) making the system difficult/complicated to accomplish tuning over a broad range of flow (impeding user friendliness),

3) subjecting the sensors to a high flow regime where otherwise calmer conditions would be a benefit to the instrumentation (according to the instrument manufacturers) and allow smaller flow cells to reduce system volume,

4) difficult to eject bubbles that would (from time to time) become entrained in the mixing loop and were likewise subject to exponential dilution,

5) difficult to fill mixing loop upon startup due to the conflict between high point to remove air and drain angle to drain liquid,

6) the connection of the pH tempering liquid to the high flow regime of the mixing loop (although it proves to work well for introducing pH tempering liquids) requires excessive backpressure at the outlet of the skid to stay flow-through of the pH tempering pump (due to venture effects) which in turn make it difficult to prime the pumps including the buffer pump on the current skid,

7) a bubbletrap is required where degassing of liquids is present (when blending organics). In the system of the '139 patent, the bubbletrap would have to be in the mixing loop with the sensors which is ineffective for removing bubbles (due to low residence time)—the sensors should be at the low flow regime before the sensors, and

8) the mixing loop is not scalable to the smaller systems because of lack of suitable centrifugal pump components.

### BRIEF DESCRIPTION OF THE DRAWINGS

FIG. 1A and FIG. 1B are one schematic of an embodiment of the multi-stage accurate blending system of the present invention.

### DETAILED DESCRIPTION OF EMBODIMENTS

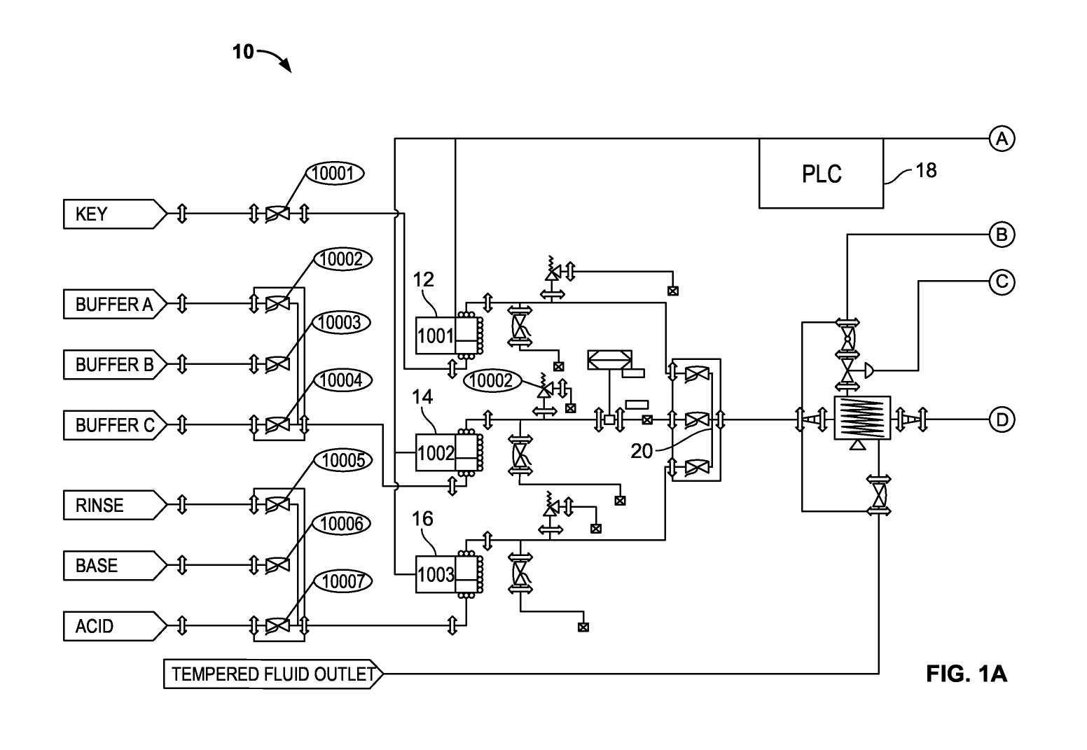

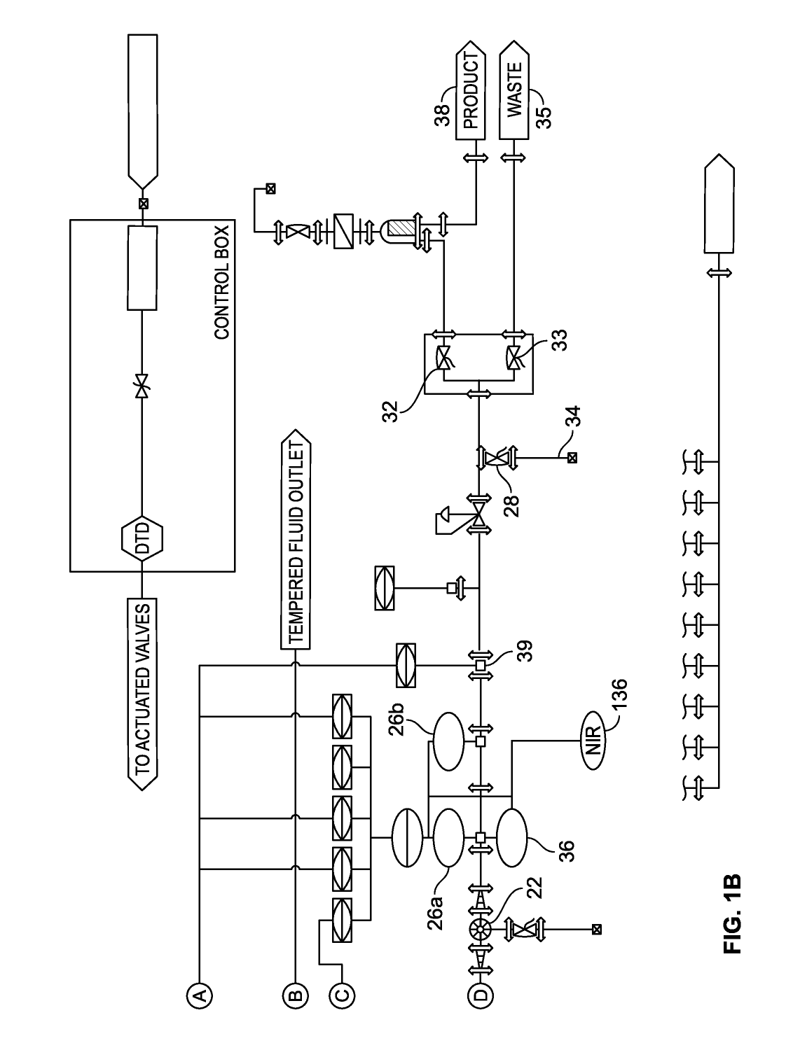

A schematic of an embodiment of the system of the present invention is provided in FIG. 1A and FIG. 1B. As illustrated in FIG. 1A and FIG. 1B, the system includes a shear blender 22. The remaining components of the system of FIG. 1A and FIG. 1B are similar to those of U.S. Pat. No. 8,271,139 to Bellafiore et al., the contents of which are hereby incorporated by reference.

With reference to FIG. 1A and FIG. 1B, a multi-stage blending system is indicated in general at 10. While this system will initially be discussed in terms of creating a buffer, it is to be understood that it may be used for accurately blending other types of liquid components. In addition, while three feed pumps and corresponding components are illustrated in FIG. 1A and FIG. 1B, the system may alternatively only feature two feeds (and thus two pumps, valves or the like) or more than three feeds.

With reference to FIG. 1A and FIG. 1B, water is provided as a feed liquid or first component to the inlet of first feed pump 12. A salt concentrate solution is provided as a first adjusting liquid or second component to the inlet of second feed pump 14. In addition, an acid/base modifier solution is provided as a second adjusting liquid or third component to the inlet of third feed pump 16. Pumps 12, 14 and 16 are preferably variable frequency drive pumps so that their pumping speeds may be accurately controlled via a programmable logic controller 18, which communicates with the pumps, valves and sensors of the system. Appropriate pumps are available, for example, from the ITT Jabsco company of Foothill Ranch, Calif.

As illustrated in FIG. 1A and FIG. 1B, the outlet streams from pumps 12, 14 and 16 are joined at junction 20 and travel to a mixing device in the form of a shear blender 22.

Automated valves providing adjustable flow rates may be substituted for some or all of the pumps 12, 14 and 16. Indeed, whether pumps or valves are used in the system to perform the metering/dosing is dependent on the application and the user's facility setup.

At start-up, pumps 12, 14 and 16 are activated by controller 18 so that solution containing salt concentrate and water and an acid/base modifier solution are pumped to the shear blender 22 and mixed therein. A purge valve 28 and a delivery valve 32 are closed, while waste valve 33 is open. As a result, solution initially exits the system through waste port 35 so that it may be dumped or directed to a container for recirculation.

Downstream of the shear blender 22 are conductivity sensors 26a and 26b and pH sensor 36.

The conductivity of the solution exiting the shear blender is detected by conductivity sensor(s) 26a and/or 26b and the total flow of the system is detected by flow transmitter 39. As illustrated in FIG. 1A and FIG. 1B, the conductivity sensors 26(a) and 26(b) and flow transmitter 39 communicate with the system controller 18 which controls pumps 12 and 14. Pump 12 is adjusted by controller 18 to the desired system flow rate based on flow transmitter 39 while pump 14 is adjusted so that salt concentrate solution is continuously delivered to the shear blender 22 in variable quantities as controlled by the controller 18.

As illustrated in FIG. 1A and FIG. 1B, a pH sensor 36 also communicates with the solution exiting the shear blender 22 to detect the pH of the solution. The pH sensor 36 also communicates with controller 18 which, as noted previously, controls pump 16. Pump 16 is adjusted so that acid/base modifier solution is continuously delivered to the shear blender 22 in variable quantities as controlled by the controller 18.

Only when the target pH and conductivity levels have been attained will the delivery valve 32 open and waste valve 33 close via controller 18 to deliver the output of the process through outlet or product port 38. The liquid traveling through outlet port 38 can be delivered to an existing process or system. The system 10 can be connected to an existing system by means of a single tubing connection or alternatively can be used in a stand-alone way to generate adaptively-controlled liquid blends.

In both the system of FIG. 1A and FIG. 1B, the target levels may be a predetermined set point or a gradient which the controller 18 may be programmed to accomplish as feedback control for pumps 12, 14 and 16. The salt concentrate solution and acid/base modifier solution addition rates continue to be based on feedback control from the conductivity sensor(s) 26a and/or 26b and pH sensor 36.

If the pH sensor 36 and/or the conductivity sensor 26 detect(s) that the solution exiting the shear blender 22 has gone out of spec, controller 18 opens waste valve 33 so that the solution is pumped out through purge line 35 so that it may be dumped or directed to a container for recirculation.

As another non-limiting example, the system of FIG. 1A and FIG. 1B may also be used to create a purifier solution. With reference to FIG. 1A and FIG. 1B, a salt concentrate solution is provided as a first adjusting liquid or component to the inlet of pump 14. Alcohol is provided as a second adjusting liquid or component to the inlet of pump 16. In addition, water is provided as a feed liquid or third component to the inlet of pump 12.

At start-up, pumps 12, 14 and 16 are activated by controller 18 so that solution containing salt concentrate, water and alcohol flows to shear blender 22 and are mixed therein. Purge valve 28 and delivery valve 32 are closed, while waste valve 33 is open.

As noted previously, downstream of the shear blender 22 are conductivity sensors 26a and 26b, In addition, in the place of the pH sensor 36 is a near-infrared (NIR) sensor, illustrated in phantom at 136 in FIG. 1B.

The conductivity of the solution exiting shear blender 22 is detected by conductivity sensors 26(a) and/or 26(b). As illustrated in FIG. 1A and FIG. 1B, the conductivity sensors 26(a) and 26(b) and flow transmitter 39 communicate with the system controller 18 which controls pumps 12 and 14. Pump 12 is adjusted by controller 18 to the desired system flow rate based on flow transmitter 39 while pump 14 is adjusted so that salt concentrate solution is continuously delivered to the shear blender 22 in variable quantities as controlled by the controller 18.

As illustrated in FIG. 1A and FIG. 1B, a near-infrared (NIR) sensor 136 also communicates with shear blender 22 to detect the alcohol concentration of the solution therein. The NIR sensor 136 also communicates with controller 18 which, as noted previously, controls pump 16. Pump 16 is adjusted so that alcohol is continuously delivered to the shear blender 22 in variable quantities as controlled by the controller 18.

Only when the target conductivity and alcohol concentration levels have been attained will the delivery valve 32 open and waste valve 33 close via controller 18 to deliver the output of the process through outlet or product port 38. The salt concentrate solution and alcohol addition rates continue to be based on feedback control from the conductivity sensor(s) 26a and/or 26b and NIR sensor 136.

In both of the above examples, the system of FIG. 1A and FIG. 1B are operated so that their first and second stages occur in a simultaneous fashion. It is to be understood, however, that the stages may alternatively be performed sequentially by the controller. More specifically, with reference to use of the system for creating a buffer as an example, pumps 12 and 14 may be controlled by controller 18 while pump 16 remains off, and delivery valve 32 closed and waste valve 33 open, during a first stage of operation. During this first stage, the conductivity sensors communicate with the controller only to control the delivery of water and salt concentration solution to shear blender 22. When the conductivity sensors detect that the solution exiting the shear blender 22 has reached the target conductivity, the first stage is completed. During the second stage of operation, pumps 12 and 14 continue to run while the controller 18 operates pump 16 so that acid/base modifier solution is delivered to the shear blender 22 as directed by pH sensor 36. Alternatively, if solution from the first stage was directed to a storage tank, it may be pumped back into the system 10 by using either pump 12 or 14 for this second stage. Delivery valve 32 is then opened when the target pH of the solution exiting the shear blender 22 is reached, since the target conductivity level was reached during the first stage.

Sensors other than a conductivity sensor, pH sensor or NIR sensor could be used as the sensors illustrated in FIG. 1A and FIG. 1B. Examples include, but are not limited to, ultraviolet sensors, temperature sensors and basically any sensor that can detect specific properties of the solution in the mixing device and outputs a measurable signal.

In addition, other analytical method(s) may be performed by embodiments of the invention. These include, but are not limited to optical methods such as refractive index (RI). In addition to RI, optical density, UV sensors, turbidity, color sensors, light scattering, etc. may be used.

A “shear blender” is typically used for grinding solids into fine granules which get entrained/homogenized in an externally forced flowing liquid (the blender is not a pump, it is a grinder which requires the solids and liquids to be pushed through it). By unintended design, the cavities between the rotating rings (of the grinder) entrains liquids and moves them in a circle where they are swept by flow through the grinder to transfer (randomly) into a stationary ring and there again swept into a rotating ring to be swept again into a stationary ring several times (5 rings in new design). There is an intense mixing effect at the transition from rotating ring to stationary ring (and vice versa) and a homogenizing effect from the random distribution of liquid from the rotating ring to the stationary ring, creating an excellent liquid mixing device which gives equivalent to better mixing results as compared to a mixing loop, and addresses the problems listed in the Background section above. More specifically, use of the shear blender provides the following advantages over use of a mixing loop:

1) changes the placement of the sensors and potential bubbletrap to downstream of the mixing device (low flow regime).

2) reduces the hold-up volume of the mixer and thereby improves the response, efficiency and tune ability of the system over a broad flow range.

3) brings the pH tempering solution to the common buffer inlet thereby eliminating the venture effect, requiring less backpressure on the system which improves priming of pump.

4) has a flow through configuration which expels air from the top and a drain at the bottom.

5) is scalable in that smaller (laboratory) versions of this device are available.

An example of a suitable shear blender 22 for use in the embodiment of FIG. 1A and FIG. 1B is Ross Model HSM-400DL, serial number 200255, available from Charles Ross & Son Company of Hauppauge, New York. The inlet and outlet connections of the shear blender preferably are modified to reduce volume.

The shear blender preferably has a variable frequency drive which may provide advantages due to normalizing the tip speed (based on rpm for fixed rotor diameter) to system flow rate.

While the preferred embodiments of the invention have been shown and described, it will be apparent to those skilled in the art that changes and modifications may be made therein without departing from the spirit of the invention, the scope of which is defined by the appended claims.

What is claimed is:

1. An accurate blending system for blending first and second liquid components comprising:
a) a first feed adapted to communicate with a supply of the first component;
b) a second feed adapted to communicate with a supply of the second component;
d) a shear blender in communication with the first and second feeds;
e) a first sensor in communication with an outlet of the shear blender;
f) a controller in communication with the first sensor so that a first characteristic of a solution exiting the shear blender can be detected, said controller also in communication with the second feed so that delivery of the second component to the shear blender can be controlled based upon the detected first characteristic.

2. The accurate blending system of claim 1 wherein the first, second and third feeds include pumps.

3. The accurate blending system of claim 1 wherein the first, second and third feeds include valves.

4. The accurate blending system of claim 1 wherein the first sensor is a conductivity sensor.

5. The accurate blending system of claim 1 wherein the first sensor is a pH sensor.

6. The accurate blending system of claim 1 wherein the first sensor is a near-infrared sensor.

7. The accurate blending system of claim 1 further comprising:
g) a third feed adapted to communicate with a supply of a third liquid component;
h) a second sensor in communication with an outlet of the shear blender;
i) said controller also in communication with the second sensor so that a second characteristic of the solution exiting the shear blender can be detected, said controller also in communication with the third feed so that delivery of the third component to the shear blender can be controlled based upon the detected second characteristic.

8. The accurate blending system of claim 7 wherein the first sensor is a conductivity sensor and the second sensor is a pH sensor.

9. The accurate blending system of claim 7 wherein the second component is a salt concentrate solution and the third component is an acid/base modifier solution.

10. The accurate blending system of claim 9 wherein the first component is water.

11. The accurate blending system of claim 7 wherein the first sensor is conductivity sensor and the second sensor is a near-infrared sensor.

12. The accurate blending system of claim 7 wherein the second component is a salt concentrate solution and the third component is alcohol.

13. The accurate blending system of claim 12 wherein the first component is water.

14. The accurate blending system of claim 7 wherein the controller is programmed to initially adjust the second and third feeds sequentially.

15. The accurate blending system of claim 14 wherein the controller is programmed to initially adjust the second and third feeds simultaneously.

16. The accurate blending system of claim 1 wherein the controller also communicates with the first feed.

17. The accurate blending system of claim 1 wherein the second component is a salt concentrate solution or alcohol.

18. The accurate blending system of claim 1 wherein the first component is water.

19. A method for blending first and second liquid components comprising the steps of:
a) providing a shear blender;
b) feeding the first component to the shear blender;
c) sensing a first characteristic of a solution in the shear blender;
d) feeding the second component to the shear blender based on the sensed first characteristic of the solution in the shear blender; and
e) mixing the first and second components in the shear blender.

20. The method of claim 19 further comprising the steps of:
sensing a second characteristic of the solution in the shear blender;
g) feeding a third liquid component to the shear blender based on the sensed second characteristic of the solution in the shear blender; and
h) mixing the first, second and third components in the shear blender.
